(19) United States
(12) Patent Application Publication
(10) Pub. No.: US 2009/0179865 A1
(43) Pub. Date: Jul. 16, 2009

(54) INTERFACE SYSTEM AND METHOD FOR MOBILE DEVICES

(76) Inventor: Avi Kumar, Cupertino, CA (US)

Correspondence Address: KUWARE, INC., 20660 STEVENS CREEK BLVD #197, CUPERTINO, CA, 95014, US

(21) Appl. No.: 12/014,101

(22) Filed: Jan. 15, 2008

(51) Int. Cl. G06F 3/041; G06F 3/033; G09G 5/08; G09G 5/00

(52) U.S. Cl. 345/173; 345/156; 345/184

(57) ABSTRACT

User input-output schemes are provided for portable computing devices such as MIDs, UMPCs, and tablet PCs. In one embodiment, a device has position indicators beside or below the device display. The indicators may be input/output controls which receive touch commands to scroll displayed information horizontally or vertically. In another embodiment, a combined user input sensor is housed in a device enclosure. The sensor includes a wheel sensor and a pointer controlling sensor presented from within the inner circumference of the wheel sensor. The wheel sensor may be a rotating wheel having a gear linkage for coupling to a transducer to detect wheel sensor movement. In another embodiment, a device operates in two modes, one mode with on screen soft buttons managed by the device hardware to provide input similar to hardware buttons, the other mode removes the device-managed buttons and allows full touchscreen display access to the operating system.

### TECHNICAL FIELD

This invention relates to input and output controls for mobile devices, especially ultra-mobile PC's and mobile internet devices.

### BACKGROUND

There is a need for computer systems that are powerful, mobile, and wirelessly connected to the internet. For example, it can be costly to purchase and maintain a laptop computer, and a PDA for pocket-portable information access, and a cellular phone. The combined size and weight of such devices also presents a burden to many business travelers, students, and other individuals who work with digital information and need to stay connected. It can also be burdensome to learn to use many different interfaces. An internet-capable PDA or PDA/phone presents one solution, but it typically frustrates internet use due to small screen size and slow keyboard typing.

A new development in portable computing, the ultra-mobile PC (“UMPC”), provides a solution having power similar to that of a notebook compute, but portability more like that of a PDA. The UMPC screen is typically larger than a PDA screen, measuring around 4-7 inches diagonally. The UMPC is therefore portable in a smaller bag than a notebook computer, or in a large jacket pocket, but not typically in a pants pocket like a PDA or cellular phone.

MIDs (Mobile Internet Devices) personalize a new category of small, mobile consumer devices providing internet browsing, coupled with the capability to communicate with others, enjoy entertainment, and access information on-the-go. They typically have smaller screens from around 4-6 inches, and more limited on-board storage than the UMPC. Some MIDs have simplified graphical interfaces, and have less PC-like applications, with a focus on email, internet, and sometimes voice. Even so, a MID may still employ file viewers to examine user data files for which it has no application to create or edit the files.

Many portable devices suffer from difficult to use interfaces with too many menus, buttons, or complicated control sequences. What is needed in the portable computer market is the need interface with the UMPC or MID easily and quickly. What is also needed are devices that provide computing power, wireless connectivity, and comparatively easy user interfaces.

### SUMMARY

User input output schemes are provided for portable computing devices such as MIDs and UMPCs. In one embodiment, mobile devices are provided with position indicators beside or below the device display. The indicators may be input/output controls which receive touch commands from the user to scroll or move displayed information horizontally or vertically.

In another embodiment, a combined user input sensor is housed in a device enclosure, the combined sensor includes a wheel sensor having an outer circumference and an inner circumference. A pointer controlling sensor presented from within the inner circumference of the wheel sensor. The wheel sensor may be a rotating wheel having a gear linkage engaging a gear wheel, which is coupled to a transducer to detect movement of the wheel sensor.

In another embodiment, a device operates in two modes, one mode with on screen soft buttons managed by the device hardware to provide input similar to hardware buttons, the other mode removes the device-managed buttons and allows full touchscreen display access to the device operating system.

Various devices and methods are provided utilizing the schemes herein. The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a front view of a mobile internet device (MID) according to one embodiment.

FIG. 1B shows an MID with an alternative arrangement of user input controls.

FIG. 1C shows a device with a cutaway view of a wheel sensor.

FIG. 2A depicts a high-level block diagram of a mobile internet device 103 (MID).

FIG. 2B shows a hardware block diagram of an ultra-mobile PC device (UMPC).

FIG. 3A is a front view of a MID according to another embodiment.

FIG. 3B is a front view of a MID with another hardware scrollbar scheme.

FIG. 4 is a block diagram of mobile device software with scrollbar interface components according to one embodiment.

FIG. 5 is a flow chart of hardware scrollbar control according to one embodiment.

FIG. 6 is front layout view of a device having device-managed soft buttons and soft-input according to another embodiment.

Like reference symbols in the various drawings indicate like elements.

### DETAILED DESCRIPTION

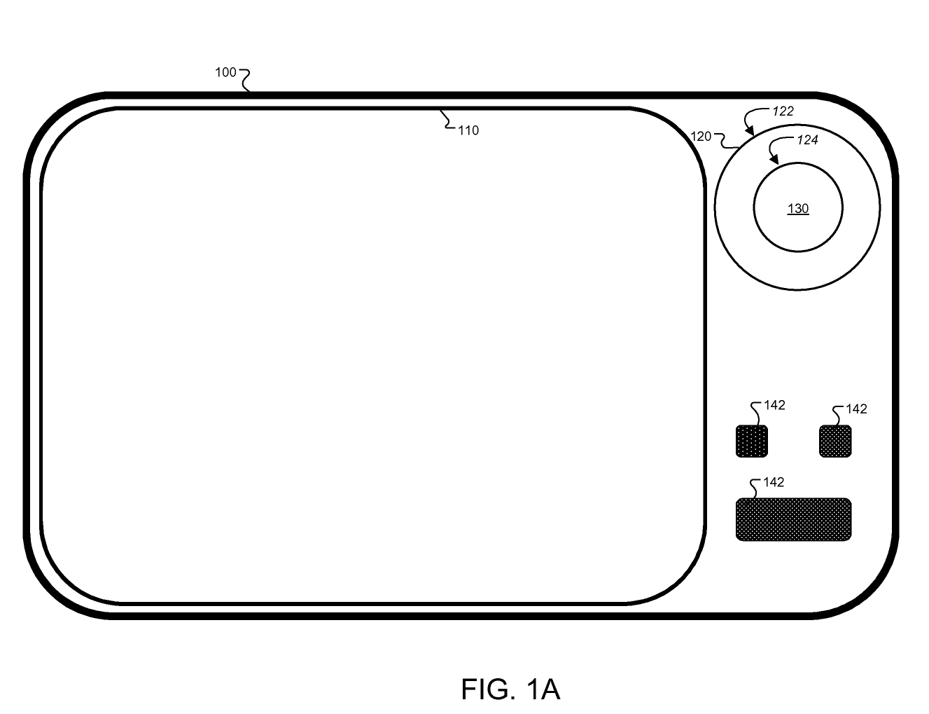

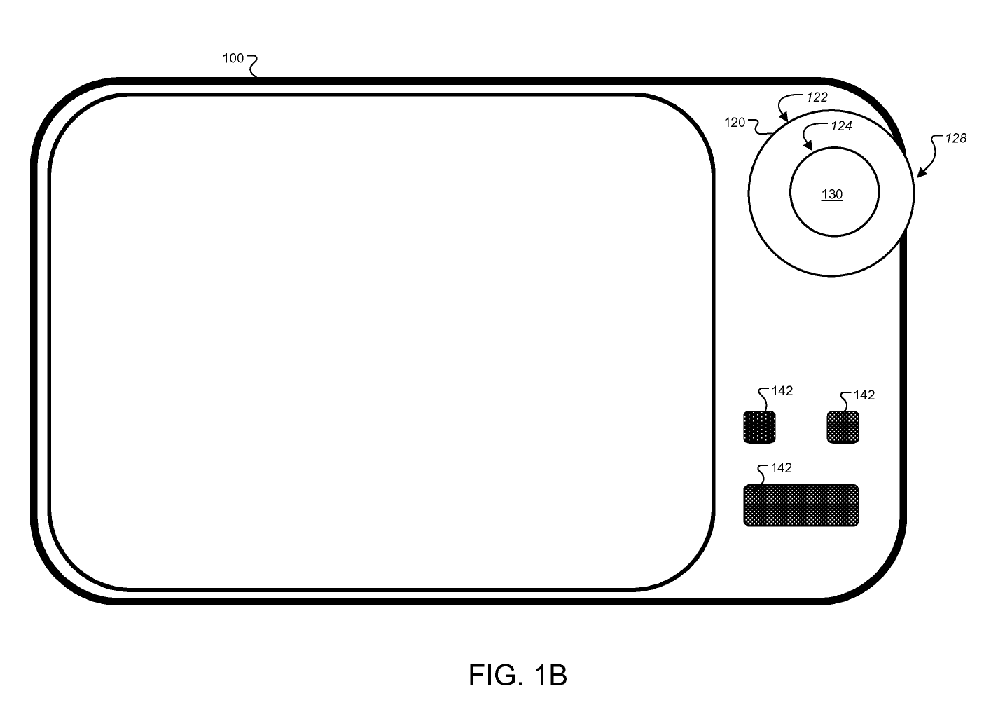

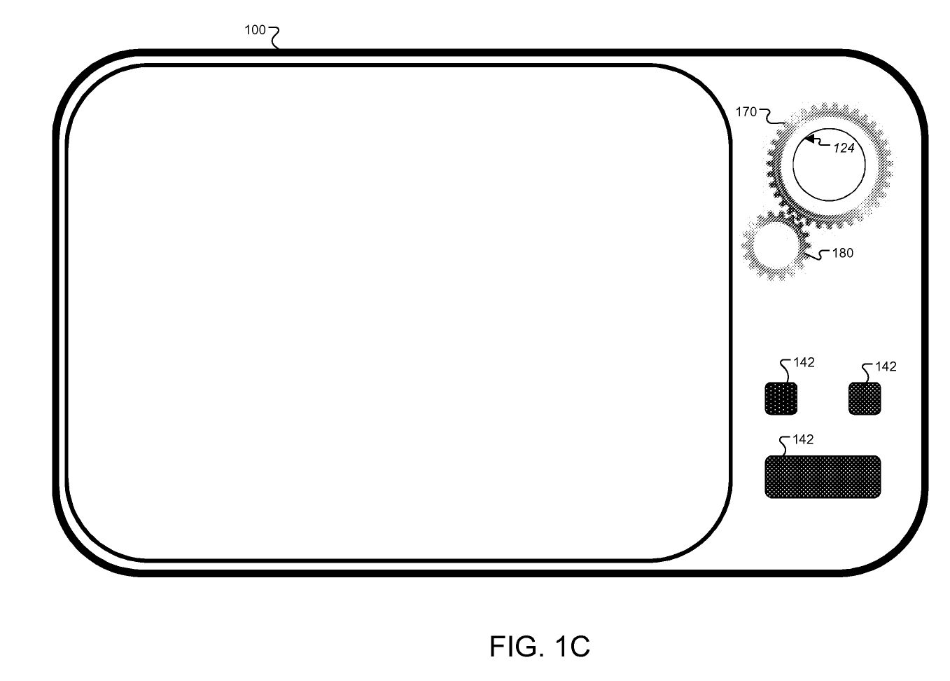

FIG. 1A is a front view of a mobile internet device (MID) according to one embodiment. The device is generally identified by its housing enclosure 100, which houses a screen 110 and various user input/output controls. The screen of an MID or UMPC is preferably a touch screen, and may also employ multi-touch capacitive touchscreen technology, or other multitouch technology. Housing 100 houses various button user controls 142 shown presented from the front surface.

A combined user input sensor 120 is housed in housing 100. The combined sensor 120 includes a wheel sensor 122 having an outer circumference and an inner circumference 124. Combined sensor 120 further includes a pointer controlling sensor 130 presented from within the inner circumference of the wheel sensor. Wheel sensor 122 and pointer controlling sensor 130 may be constructed in a variety of ways. One preferred wheel sensor 122 includes a wheel touch sensor with a plurality of touch sensitive segments arranged in a circle. Another embodiment includes a mechanical wheel which turns in place in housing 100. This version may have a textured surface to facilitate user movement of the wheel with thumb or finger. The pointer controlling sensor 130 enables movement of a pointer or cursor on the screen, a replacement for a mouse input. Sensor 130 is preferably a pointing stick with a broader-than-normal top surface to facilitate more accurate movement control and thumb contact. Sensor 130 may also be a small touch pad or a combined pointing-stick/touchpad with precision movement controlled by the touchpad and higher velocity movement provided with sideways pressure on the pointing stick (nub). Downward pressure on the pointing stick may also provide a click button event or press-to-select event.

FIG. 1B shows an MID with an alternative arrangement of user input controls. In this embodiment, the wheel sensor 122 is arranged to be accessible from the side edge of device 100 by presenting an extended portion 128 past the edge of housing 100. The wheel preferably has grooved or textured edges to better engage user touches.

FIG. 1C shows a device with a cutaway view of a wheel sensor 122. Circular movement of the wheel is allowed around inner circumference 124, through which projects the sensor 130 (FIG. 1A). A lower portion of rotating wheel sensor 122 is provided with a gear linkage 170. This matches to a gear wheel 180, which allows measurement of circular movement with a transducer such as a circular potentiometer or other suitable sensor. Use of the depicted gear wheels allows rotational movement sensing of wheel sensor 122 despite the extra sensor 130 centrally disposed therein. The depicted gear wheel 180 has a smaller radius than the gear linkage 170 on wheel sensor 122. This provides greater rotational movement of wheel 180 allowing more accurate measurement.

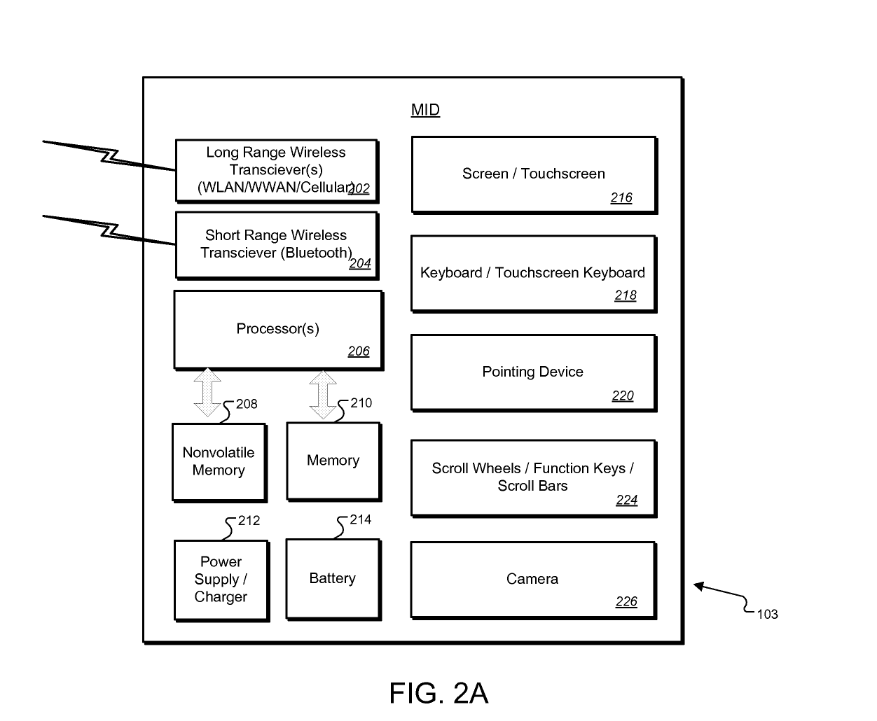

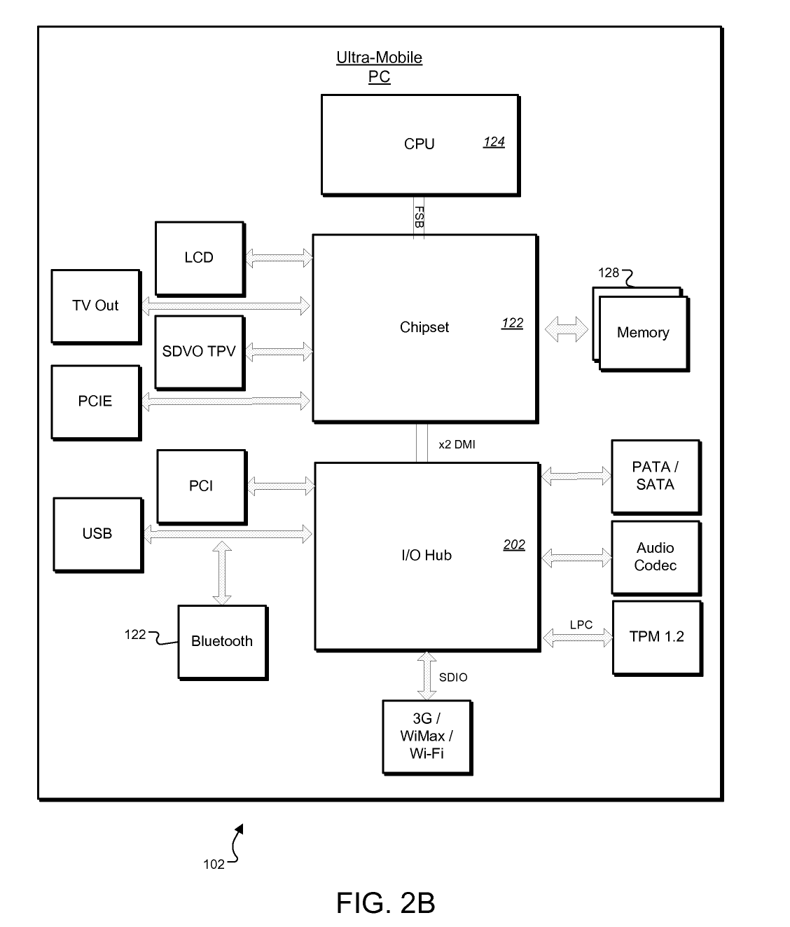

FIG. 2A depicts a high-level block diagram of a mobile internet device 103 (MID). The MID 103, as discussed above, is a mobile internet device providing connectivity, email, and entertainment. The depicted MID 103 includes a long range wireless transceiver 202 such as a cellular/3G cellular or Wi-max transceiver (these typically include a Wi-fi WLAN capability as well). It also includes a short-range wireless transceiver 204, preferably Bluetooth for communicating in a personal area network environment such as to a headset or wireless keyboard.

The preferred screen size for a MID can range from that of a UMPC screen to that of a large PDA-sized display. Such a range is typically around 4 to 7 inches, with a smaller 4-6 inch display preferred. A screen having resolution of 140-160 pixels per inch is preferred. While higher resolution screens are predominantly used in the industry as of the filing of this application, such a resolution provides suitable pixel density for viewing web page graphics and text without resizing and accompanying distortion. A detailed discussion of screen sizes and resolutions for mobile internet devices is provided in U.S. patent application Ser. No. 10/891,544 by Matt Pallakoff, which is hereby incorporated by reference in its entirety for all purposes. A preferred screen size and resolution for devices herein provides an effective pixel count in the first dimension inclusively between 520 and 720 effective pixels, and an effective pixel count in the second dimension inclusively between 360 and 440 effective pixels, and the effective pixel density is inclusively between 130 and 162 effective ppi.

The MID screen may be a touch screen, depending on the product and whether/what keyboard is present. Also included on some MIDs are user I/O devices 126 such as a mousepad or mouse-nub, and various scroll wheels and function keys 224.

The processor 206 is logically connected to nonvolatile memory 208 such as, for example, a hard drive, flash drive, or hybrid drive. Processor 206 employs system memory 210 in operation.

FIG. 2B shows a hardware block diagram of an ultra-mobile PC device (UMPC), general construction of which has been known in the art for over a year at the time of this filing. The depicted device 102 has a CPU 124, which may be single or multiple core processor. A presently preferred embodiment employs an Intel® A100 or A110 processor, designed for low power portable applications. Other processors may, of course, be used. The depicted chipset 202 connects to CPU 124 via the frontside bus. A preferred design is based on low-power Intel® architecture optimized for use in ultra-mobile devices, and provides an Intel® 945GU Express Chipset (202) and Intel® I/O Controller Hub ICH7 for the depicted I/O hub 204.

Chipset 202 contains a memory controller for accessing memory 128, and suitable I/O circuitry for controlling an LCD, a TV Out port, an SDVO port (Serial Digital Video Out), and a PCIE (Peripheral Component Interconnect Express) bus for communication with peripheral devices. The preferred screen size for a UMPC can range from that of an ultra-portable laptop to a large PDA-sized display. Such a range is typically around 4 to 7 inches, with a larger 6-7 inch display preferred. A screen having resolution of 140-160 pixels per inch is preferred. The UMPC screen may be a touch screen, depending on the product and whether/what keyboard is present. Also included on a typical UMPC are devices 126 such as a mousepad or mouse-nub, and various scroll wheels and function keys 128.

A Direct Media Interface (DMI) bus connects the depicted chipset 202 and I/O hub 204. This interface is preferably a high-speed, bidirectional, point-to-point link supporting a data rate of 1 GB per second in each direction.

I/O hub 204 provides further input/output connectivity such as the parallel or serial ATA data storage interface, the audio Codec for speakers and microphone functionality, and the trusted platform module 1.2 interface supporting secure digital storage. I/O hub 204 further provides a PCI bus interface and a USB interface. A camera may be provided, as well as the Bluetooth link 122. Also provided are wireless transceiver(s) preferably providing Wi-fi WLAN capability and WWAN capability through a 3G or Wi-max long range radio.

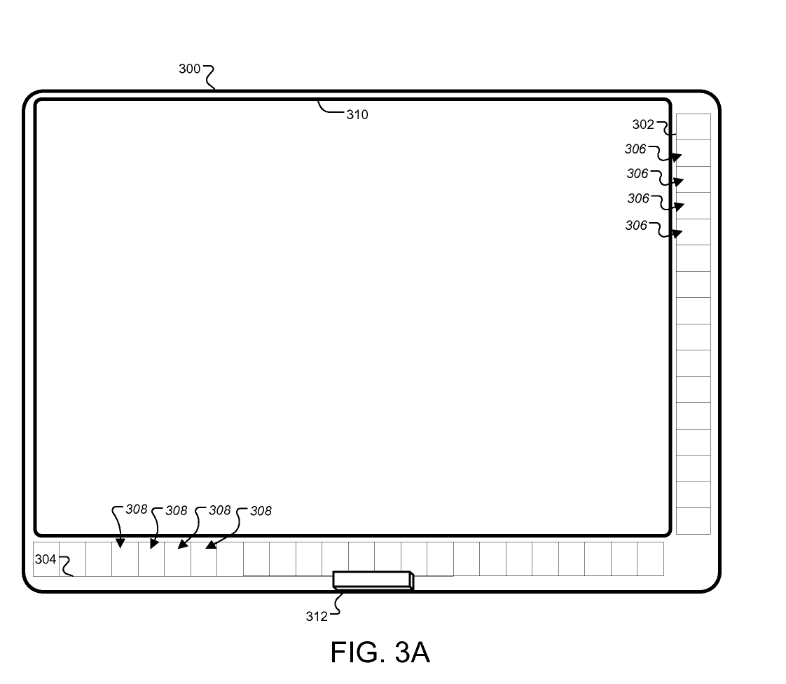

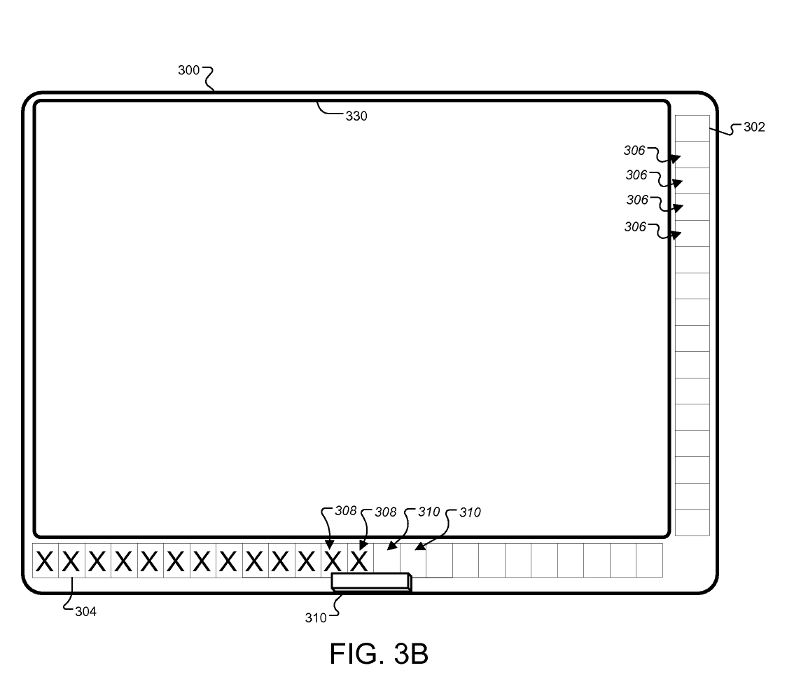

FIG. 3A is a front view of a MID according to another embodiment. The depicted device has a housing enclosure 300 holding a screen 310, preferably a touch screen with multi-touch capability. To the right of screen 310 is a hardware scrollbar or vertical control 302.

The depicted scrollbar 302 is an input-output device, not merely an input device like known scrollbars. Each of the depicted segments 306 contains an LED or other visual indicator to show the current scroll position of the active window in the device. Scrollbar 302 may be constructed with a series of touch sensors in close proximity (or combined) with LEDs. While the scrollbar 302 is shown with large segments, preferably the bar has many more smaller segments for high resolution position display and touch input. Scrollbar 302 may also be constructed with a thin strip of touch sensitive display. While the depicted embodiment example embodiment contains one touch sensor for each LED (each segment is a touch sensor and LED), this is not limiting and more or less LEDs may be used. For example a scrollbar 302 may have 100 small LEDs and 50 touch sensors. Further, in preferred embodiments, location of scrolling movement is not matched directly to scroll position. For example, a window may present a scroll position indicator lighted toward the top of hardware scrollbar 302, but the user may scroll with relative movement conducted entirely toward the lower end of scrollbar 302. The position indicator thereby does not have to be “touched” like a typical software scrollbar position indicator (which may be relatively small in a large window, thus requiring very precise pointer movements in a typical software scrollbar).

Preferably there is a small gap between the screen 310 and the hardware scrollbars to avoid touch errors when using a touch screen. For non-touch screens, no gap is needed. Scrollbars can also be implemented by an extended portion of a touchscreen. Such an embodiment would preferably have a brighter position indicator (more contrast with the “slot”) than traditional software scrollbars, which are difficult to see in bright lighting. Also, such an embodiment preferably has a small strip of “dead” area, nonresponsive to touch, between the display area and the scrollbar area. In one version, the “dead” area may be covered with a raised border to further separate the scrollbar function from the touch display function.

Disposed along the lower side of screen 310 is another hardware scrollbar 304 for horizontal scrolling. Each of segments 308 is a touch sensor and position display indicator. Also at the bottom center of the screen, in this embodiment disposed below scrollbar 304 and at the edge of housing 300, is a context modifier button 312. They provide a right-click capability matched for touches on a touch screen, as well as shift-key functionality for touchscreen keyboards. The context modifier may modify other functions of soft or hard buttons or controls from a first function to a second function. For example, scrollbar 302 or 304 may provide a zoom function when combined with a held-down context modifier button. Note that the context modifier button 312 is preferably not a “CAPSLOCK” key; it must be held down for context modification. While the context modifier button 312 is shown centrally disposed along the bottom (relative to the display) of the device, this is not limiting and other suitable locations may be used. For example, one version uses two context modifier buttons 312 presented along opposite edges of the device, and placed high enough along the edge so that 1) they do interfere with a two-handed “thumb typing” grip and 2) they are in easy reach of the pad of the thumb using the same grip. This provides a modifier button for each hand. Another version is a right-handed device with only one button, similarly positioned.

The device may include other buttons on the front or edges of the housing, for example a “home” button bringing the user back to device home screen. One button combination includes two buttons with the context modification button and a “home” button. A third button a “back” button may be added, which changes applications or views to the last screen of input, last file or web location, or last application used. Another button useful on MID devices is a “context sensitive” button, which has different functionality dependent on application and application context.

FIG. 3B is a front view of a MID with another hardware scrollbar scheme. In this embodiment, the depicted elements are similar to those in FIG. 3A, except that the lower hardware scrollbar 304 is shown with half of the sensor/position indicator elements 308 marked with X to indicate that they are not functional for touch input, but still function as position indicators. This allows horizontal scroll functions to be performed with one hand using the depicted active half of the hardware scrollbar (elements 310). While a version is shown to receive horizontal scroll input on the right side, a mirror image of the depicted device may also be used, moving both the vertical hardware scrollbar 302 and the input portion of horizontal scrollbar 304 to the left side. Further, while the vertical scrollbar 302 is shown completely functional in this version, a portion may similarly be disabled for touch, but enabled for position indication. This modification provides less improvement than modifying scrollbar 304 because the higher portions of bar 302 might 1) be used in a modified grip and 2) are less likely to interfere with the users grip holding the device. Partially disabled sensor/position elements 308 may chosen such that they provide touch insensitivity where they may interfere with the user's grip on the device. This will vary between devices, but may be, for example, 20%, 30%, 40%, or 50% of the length of scrollbar 304 from the left edge.

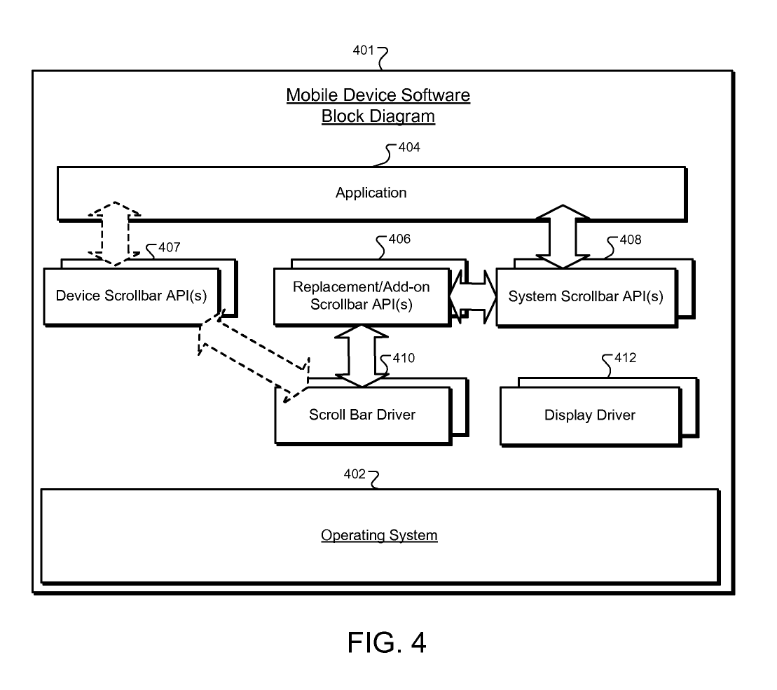

FIG. 4 is a block diagram of mobile device software with scrollbar interface components according to one embodiment. The depicted device 401 in FIG. 4 includes operating system 402 and numerous drivers, API's, and software applications. Only the relevant software objects are shown to simplify the drawing.

Operating system 402 may be a linux variant, Windows, or Windows mobile, for example. Installed in the system are various applications such as application 404, which may be controlled by hardware scrollbar input through the depicted drivers and API's. Note that various operating systems may have more than one system scrollbar API 408 for use from, for example, Java or C++ applications. The system scrollbar API 408 presents functions that implement horizontal and vertical software scrollbars, which are well known in the art as allowing movement within a displayed file that is larger than the window space. The windows are displayed on the device screens by display driver 412, and mouse input scrolls the windows on the screen through interaction with the window scrollbars.

Shown are two ways to implement interaction with hardware scrollbars on the device. The dotted arrows represent the first option, and solid arrows the second. The first involves use of one or more device scrollbar API's 407 together with scrollbar driver 410. The driver 410 interacts with the hardware scrollbars on the device to receive input signals and output position data for display by the scrollbar. The device scrollbar API 407 is a software module presenting scrollbar functions for use by application 404. API 407 is preferably compiled specifically for the device and implements scrollbar input and output configured specifically for the number and arrangement of hardware scrollbars on the device. Further, API 407 includes software instructions for input and output of movement and position information to driver 410. Preferably, the API is provided during the application development stage, for example, with a device-specific SDK. The functionality is then with the device.

The second hardware/application interaction method involves communication through replacement or add-on scrollbar API 406. This API presents a set of functions that replaces or augments the system scrollbar API 408 to provide the expanded functionality of hardware scrollbar interaction. In this version, the software applications that were designed and written to employ standard software scrollbars need not be modified to work with hardware scrollbars because their API calls are not altered. The API itself is replaced or augmented to provide the additional input output functionality. The alteration or replacement of API functions may involve replacement or alteration of executable binaries such as DLLs. However, this is not necessary for all embodiments. Other embodiments may alter the DLL function tables (such as an import address table) to point to executable code for modified functions in API 406.

The add-on/replacement scrollbar API 406 may also be used to modify the function or display of the software scrollbar, or remove it altogether. This may be based on default or user settings regarding preferred scrollbar configuration.

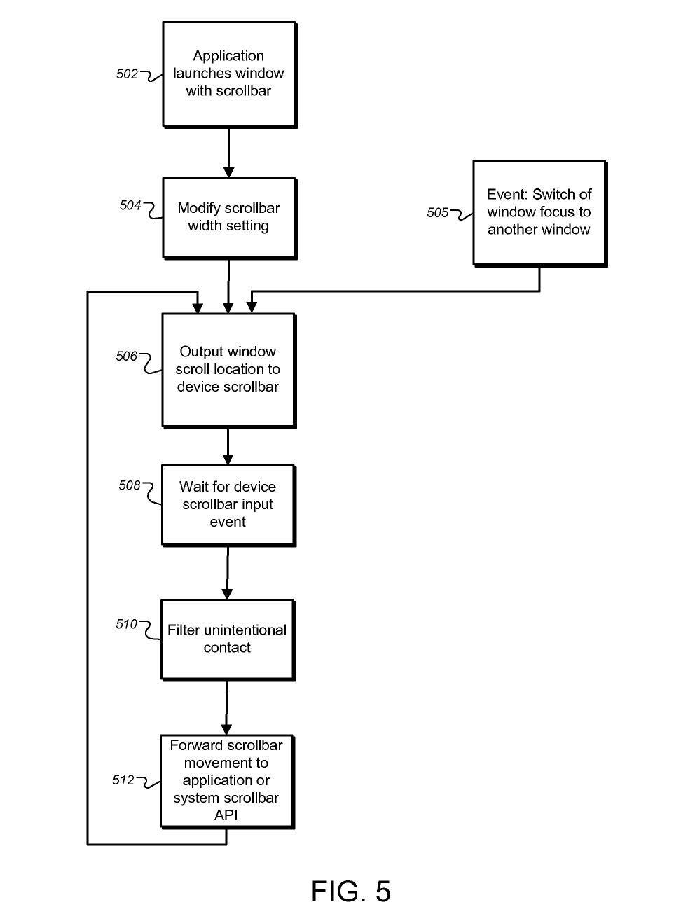

FIG. 5 is a flow chart of hardware scrollbar control according to one embodiment. Some of the steps are system steps, while others are performed by scrollbar driver 410 (FIG. 4) or the various scrollbar API's.

In step 502, an application launches a window that requires a scrollbar. This typically occurs when the window content is larger than the display area, for example when a document or webpage is launched that will not fit horizontally or vertically within the launched window. At step 504, the scrollbar API provides a modified scrollbar width for the displayed software scrollbar. This may reduce the width to zero or non-visible width, to rely exclusively on the hardware scrollbar. Another version may reduce the width to a certain visible fraction of the original. Another version may increase the width to provide a software scrollbar on a touchscreen display that is more easily dragged with a finger or thumb touch on the screen.

At step 506, the hardware API and driver output the present window scroll location to the device hardware scrollbar. One of these modules may modify the format of the location provided in the system. For example, if the location is provided as an integer percentage or position along the software scrollbar, this step may rescale or change the format of the integer percentage value to a format more useful in the display driver. This may be, for example, an integer position value scaled to fit the number of displayable positions on the hardware scrollbar. Upon output, the scrollbar displays the position until a new position is provided or another exiting even occurs (for example, the window is closed or the file no longer requires a scrollbar, etc).

At step 508, the process waits for device scrollbar input event. This may occur only at the hardware scrollbar driver, or may occur simultaneously in software scrollbar code modules, when both are used together.

Step 510 filters unintentional contact from the hardware scrollbar. This step is needed on devices where the user grip may occasionally shift and contact the hardware scrollbar, or where certain user movements may bring about unintended contact with the hardware scrollbar. The filtering performed at step 510 may include one or more of several different techniques to filter touches. A touch over a minimum length of the scrollbar simultaneously may be filtered. Pressure may also be used, with minimum and maximum thresholds to determine intentional touch. Speed of movement may also be used, with fast brushing movements ignored as unintentional touches. Because the preferred hardware scrollbar includes multiple touch sensors, it has “multitouch” capability. This raises more issues in determining whether a particular touch of a multiple touch scenario is intentional. For example, a non-moving constant touch, especially toward the lower edge of the device, may be ignored while a simultaneous moving touch of sufficient pressure is passed as an intentional touch. Further, while a “filter” is discussed, this is only a logical description and the actual processing may be combination of rule-based software decisions and other techniques such as DSP processing, etc. A digital filter is not intended as the only component or sole embodiment. Preferably, the filtering functionality is implemented in the software driver. This functionality may be further controlled through software settings such speed and pressure thresholds that may be determined by user settings or measuring user activity, for example.

At step 512, intentional touches are forwarded to the scrollbar API and then to the application to implement the scrollbar movement. Step 512 may also include altering the touches received to implement acceleration or scaling of the movement. For example, faster movements may be given greater amplification. A fast movement one-half the length of the screen along a scrollbar may provide a scrolling movement of one screen or more. Preferably, linear movements are amplified by at least 2× to provide easy scrolling without excessive user movement. This may vary by setting. Another feature implemented at this stage may be continuous scrolling or a simulated “spinning scroll wheel,” which continues scrolling movement after a fast scroll with a release of pressure rather than a stopping movement (scroll with stop leaving thumb on the scrollbar). The movement is stopped with another touch of the scrollbar. The continuous scroll speed may be determined by the speed of scrollbar movement before release. For example, a released scroll movement with a slow speed may cause continuous scrolling movement at a first, slow speed, and a released scrolling movement with a fast speed may cause continuous scrolling movement at a second, fast speed.

From step 512, the process returns to step 506 to output the new position (returned from the application or scrollbar API) to the device scrollbar for display.

Step 505 is called in response to a focus switch event switching to another window. This step jumps into step 506 and outputs the new window location to the scrollbar. If no scrollbar is present in the new window, this step will turn off the scrollbar. All of the steps herein may apply equally to horizontal or vertical hardware scrollbars, or both simultaneously.

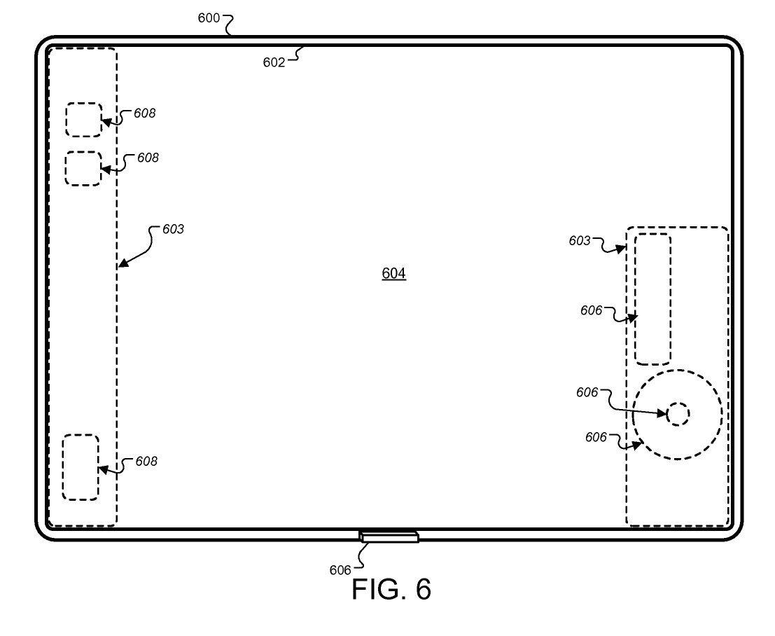

FIG. 6 is front layout view of a device having device-managed soft buttons and soft-input according to another embodiment. The depicted device is identified by housing 600 which includes a touchscreen 602. In this embodiment, the screen is larger than a typical MID or UMPC device, and is closer to a tablet-sized screen. The screen is operable in two modes. In the first mode, the operating system and applications on the device have access to the full screen 602 as a display. In such a mode, all touch activity on touchscreen 602 is directed through the operating system or applications running on the device. This represents a standard, known method of using touchscreen displays.

In response to certain switch events, the device 600 will switch from the first mode to a second mode in which the operating system has access to only a subset of touchscreen 602 for display. This subset, in the depicted embodiment, is the area labeled 604 between the two depicted rectangles 603. The remaining touchscreen areas 603 are now dedicated to soft keys 608 and other soft inputs 606 which are displayed on this screen from updateable Non-Volatile ROM. The effect of touching these inputs 606 and 608 is same as touching hard keys and conveyed to operating system accordingly. The depicted soft inputs 606 are a scrollbar and a clickwheel, which are only shown for example. The scrollbar may be an input/output scrollbar as elsewhere described herein. A thin frame of disabled touchscreen may be present around the soft input areas 603, to prevent touch function crossover. As shown with the right-side area 603, the soft button area need not extend the entire height of the display, although it preferably does to allow a rectangular display for operating system access. Another embodiment may similarly provide a touchscreen keyboard.

The described scheme of switching modes allows a large display with no screen real estate loss when operating with full keyboard/mouse etc., attached, and allows access to smaller display but complete functionality when operating with no keyboard or inaccessible keyboard, such as, for example, in a convertible tablet mode. Thus, in one embodiment, a switch from laptop mode to tablet mode in a convertible computer triggers a switch event causing a change from the first mode to the second mode. Other suitable switch events may be used. For example, a switch input positioned on the device housing may control the mode change. As another example, removing the device from a docking station or wireless docking environment may cause a switch event to the second mode.

While various embodiments are taught herein, this specification should be interpreted to teach any operable combination or subcombination of features herein.

A number of embodiments of the invention have been described. Nevertheless, it will be understood that various modifications may be made without departing from the spirit and scope of the invention. Accordingly, other variations are within the scope of the following claims.

What is claimed is:

1. A portable electronic device for displaying information, the device comprising:
an enclosure;
a display comprised in the enclosure such that an active surface of the display is visible;
a vertical control separate from the display and disposed along a right or left side of the display, the vertical control and operable to vertically move content displayed by the active surface of said display, the vertical control including a current position indicator.

2. The device claim 1 further comprising one or more horizontal controls separate from the display and operable to horizontally move content displayed by the active surface of said display, at least one of the one or more horizontal controls including a position indicator.

3. The device claim 2 further comprising a controller operable to control the display and the position indicator, the controller operable to switch display focus from a first displayed window to a second displayed window and change the position indicator of the at least one horizontal control from a position of the first window to a position of the second window.

4. The device claim 1 in which the position indicator comprises one or more LEDs.

5. The device claim 1 in which the position indicator comprises a display strip.

6. The device claim 1 further comprising a controller operable to control the display and the position indicator, the controller operable to switch display focus from a first displayed window to a second displayed window and to change the position indicator of the vertical control from a position of the first window to a position of the second window.

7. The device claim 1 further comprising a controller operable to control the display and the position indicator, the controller operable to provide vertical scroll position information of a displayed window for controlling a position indicator of the vertical control, the controller further operable to reduce a thickness of an intended software scrollbar on the display, or remove the intended software scrollbar entirely from the display.

8. A portable electronic device for displaying information, the device comprising:
an enclosure;
a display comprised in the enclosure such that an active surface of the display is visible;
a combined user input sensor housed in the enclosure, the combined sensor comprising a wheel sensor having an outer circumference and an inner circumference, the combined sensor further comprising a pointer controlling sensor presented from within the inner circumference of the wheel sensor.

9. The device of claim 8 in which the wheel sensor comprises a rotating wheel.

10. The device of claim 9 in which the rotating wheel further comprises a gear linkage adapted to engage a gear wheel mounted in the enclosure, the gear wheel adapted to have rotational movement measured with a sensor.

11. The device of claim 10 in which the gear wheel has a smaller gear radius a radius of the rotating wheel gear linkage.

12. The device of claim 9 in which the pointer controlling sensor comprises a convex traction surface.

13. The device of claim 9 in which the rotating wheel is accessible from a display-side surface of the device and from a side edge of the device.

14. The device of claim 9 in which the rotating wheel is accessible from a display-side surface of the device, but not from a side edge of the device.

15. A method of method of outputting information to a user of a portable electronic device, the method comprising:
displaying information on a display screen of the portable device; and
displaying a position indicator on a user input output control disposed alongside the display screen.

16. The method of claim 15 further comprising receiving positioning command information from the user input output control and, in response, repositioning the displayed information.

17. The method of claim 16 in which receiving positioning command information comprises receiving data from at least one of multiple touch sensors arranged in a row.

18. The method of claim 16 in which receiving positioning command information comprises receiving data from a touch-sensitive strip.

19. The method of claim 15 in which displaying the position indicator comprises activating at least one LED.

20. The method of claim 15 further comprising switching display focus from a first displayed window to a second displayed window and changing the position indicator from a position of the first window to a position of the second window.

21. The method of claim 15 further comprising reducing a thickness of an intended software scrollbar on the display.

22. The method of claim 15 further comprising removing an intended software scrollbar from the display.
